(19) United States
(12) Patent Application Publication
(10) Pub. No.: US 2025/0242610 A1
(43) Pub. Date: Jul. 31, 2025

(54) LIQUID DISCHARGE APPARATUS

(71) Applicant: Yuuta AOKI, KANAGAWA (JP)

(72) Inventor: Yuuta AOKI, KANAGAWA (JP)

(21) Appl. No.: 19/023,289

(22) Filed: Jan. 16, 2025

(30) Foreign Application Priority Data
Jan. 30, 2024 (JP) 2024-012078

(51) Int. Cl. B41J 11/06; B41J 2/005; B41J 3/407; B41J 11/00; B41J 11/70; B41J 15/04

(52) U.S. Cl. CPC B41J 11/06; B41J 2/0057; B41J 3/4078; B41J 11/0015; B41J 11/706; B41J 15/04

(57) ABSTRACT

A liquid discharge apparatus includes a liquid discharger, a platen, a heater, and an anti-slip member. The liquid discharger discharges a liquid onto a transfer substrate. The heater is disposed on the platen. The heater heats the transfer substrate over the platen. The anti-slip member is disposed on the heater. The anti-slip member has a surface on which the transfer substrate is placeable.

### CROSS-REFERENCE TO RELATED APPLICATION

This patent application is based on and claims priority pursuant to 35 U.S.C. § 119 (a) to Japanese Patent Application No. 2024-012078, filed on Jan. 30, 2024, in the Japan Patent Office, the entire disclosure of which is hereby incorporated by reference herein.

### BACKGROUND

### Technical Field

The present disclosure relates to a liquid discharge apparatus.

### Related Art

In the related art, a liquid discharge apparatus such as an inkjet recording apparatus uses an inkjet technique. As the liquid discharge apparatus, a direct to garment (DTG) printer and a direct to film (DTF) printer are known in the art.

The DTG printer performs printing directly on a recording medium such as a garment. The DTG printer performs printing on the recording medium set on a platen (holder). The DTF printer applies ink to a transfer substrate such as a film and heats the transfer substrate to form an image to be transferred. For example, thermally soluble adhesive powder is applied to the image to be transferred, and the ink (i.e., an image) on the film is transferred to a transfer target such as a garment.

### SUMMARY

The present disclosure described herein provides an improved liquid discharge apparatus including a liquid discharger, a platen, a heater, and an anti-slip member. The liquid discharger discharges a liquid onto a transfer substrate. The heater is disposed on the platen. The heater heats the transfer substrate over the platen. The anti-slip member is disposed on the heater. The anti-slip member has a surface on which the transfer substrate is placeable.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic perspective view of a liquid discharge apparatus;

FIG. 2 is a schematic plan view of the liquid discharge apparatus of FIG. 1;

FIG. 3 is a schematic front view of the liquid discharge apparatus of FIG. 1;

FIG. 4 is a schematic cross-sectional side view of a platen according to a first example;

FIG. 5 is a schematic cross-sectional side view of a platen according to a second example;

FIG. 6 is a schematic side view of a platen and the surroundings thereof according to a third example;

FIG. 7 is a schematic plan view of a part of the platen of FIG. 6 and the surroundings thereof as viewed from above;

FIG. 8 is a schematic plan view of a transfer substrate on a platen according to a comparative example; and

FIG. 9 is a schematic view of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus according to embodiments of the present disclosure is described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

The liquid discharge apparatus according to an embodiment of the present disclosure includes a liquid discharger that discharges a liquid onto a transfer substrate and a holder on which the transfer substrate is placed. A heater is disposed on the holder, and an anti-slip member is disposed on the heater.

According to one aspect of the present disclosure, in the liquid discharge apparatus that employs the DTG system and includes the holder such as a platen, when a transfer substrate for forming an image by the DTF system is used, the transfer substrate can be easily placed on the holder, the transfer substrate can be dried favorably, and an abnormal image can be prevented.

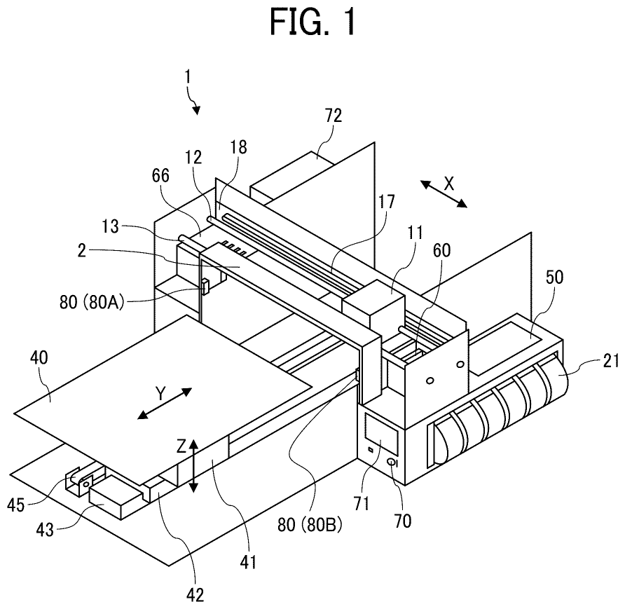

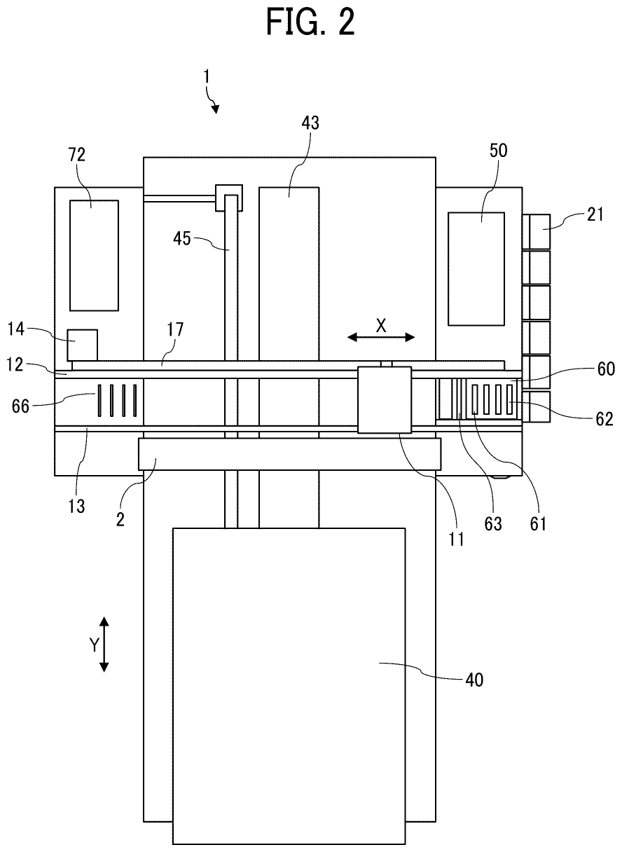

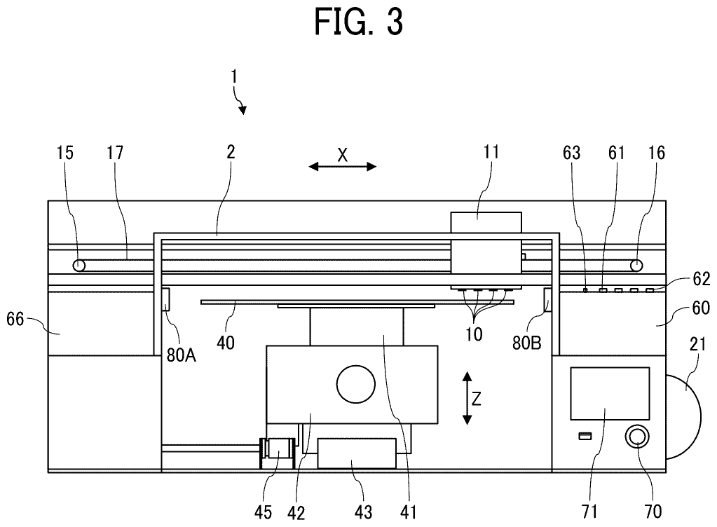

A liquid discharge apparatus 1 will be described below with reference to FIGS. 1 to 3. FIG. 1 is a schematic perspective view of the liquid discharge apparatus 1, FIG. 2 is a schematic plan view of the liquid discharge apparatus 1, and FIG. 3 is a schematic front view of the liquid discharge apparatus 1.

The liquid discharge apparatus 1 employs the DTG system and includes the holder such as a platen 40. As the liquid discharge apparatus 1, for example, a DTG printer such as a serial inkjet garment printer, i.e., a so-called T-shirt printer can be used. An example of printing by the DTG system will be described below. In this example, the printing performed on a fabric will be described below.

The terms “image formation,” “recording,” “printing,” “image printing,” and “fabricating” used herein may be used synonymously with each other.

The liquid discharge apparatus 1 includes heads 10 as liquid dischargers (see FIG. 3) to discharge a liquid and a carriage 11 mounting the heads 10. Guides 12 and 13 hold the carriage 11 such that the carriage 11 is reciprocally movable in a main scanning direction X. The carriage 11 is coupled to a timing belt 17 looped around a drive pulley 15 rotated by a main scanning motor 14 and a driven pulley 16 (see FIGS. 2 and 3). The main scanning motor 14 is driven to reciprocally move the carriage 11 in the main scanning direction X.

The liquid discharge apparatus 1 includes an encoder sheet 18 extending in the main scanning direction X. The encoder sheet 18 includes slits periodically formed in the encoder sheet 18. The carriage 11 includes a reading sensor that reads the slits in the encoder sheet 18. The liquid discharge apparatus 1 can detect the position of the carriage 11 in the main scanning direction X from a reading result of the reading sensor.

The liquid discharge apparatus 1 includes a controller board 50 that controls the heads 10 to discharge an ink as a liquid from the heads 10 at a timing when the carriage 11 is moved to a discharge position. A position of the carriage 11 (carriage position) is obtained from the reading result of the reading sensor of the carriage 11.

The liquid discharge apparatus 1 includes four heads 10 mounted on the carriage 11. For example, each of the heads 10 includes two rows of nozzle arrays on a nozzle face of the head 10. Each nozzle array includes nozzles from which a liquid is discharged. The carriage 11 also mounts a sub tank to temporarily store a liquid to be supplied to the heads 10. A liquid of a desired color is supplied from a main tank 21 to the sub tank via a supply tube by a liquid feed pump.

The liquid discharge apparatus 1 includes the platen 40 as the holder to hold a fabric. The liquid discharge apparatus 1 includes a lift 41 on which the platen 40 is mounted. The position (height) of the lift 41 is adjustable in a vertical direction Z.

The liquid discharge apparatus 1 includes a slider 42 on which the lift 41 of the platen 40 is mounted. The liquid discharge apparatus 1 includes a slider rail 43 on which the slider 42 is movably mounted. The slider rail 43 extends in a sub-scanning direction Y. The sub-scanning direction Y is orthogonal to the main scanning direction X. Thus, the slider 42 moves along the slider rail 43 in the sub-scanning direction Y.

The slider 42 is reciprocally movable in the sub-scanning direction Y via a timing belt 45 by a sub-scanning drive mechanism. The slider 42 is reciprocally moved in the sub-scanning direction Y to reciprocally move the platen 40 in the sub-scanning direction.

The liquid discharge apparatus 1 includes a maintenance unit 60 to maintain and recover a discharge function of the head 10. The maintenance unit 60 is disposed on one end (right side in FIGS. 2 and 3) of the liquid discharge apparatus 1 in the main scanning direction X. The maintenance unit 60 includes a suction cap 61, a moisture-retention cap 62, and a wiper 63. The suction cap 61 caps the nozzle face of the head 10. The moisture-retention cap 62 caps the nozzle face of the head 10 to keep moisture in the nozzles of the head 10. The wiper 63 wipes the nozzle face of the head 10. The suction cap 61 is coupled to a suction pump.

The liquid discharge apparatus 1 includes a discharge receptacle 66 on the other end (left side in FIGS. 2 and 3) of the liquid discharge apparatus 1 in the main scanning direction X. The controller board 50 controls the head 10 to discharge the liquid to the discharge receptacle 66 during printing to maintain and recover the discharge function of the head 10.

Further, the liquid discharge apparatus 1 includes a height detector 80 that includes a light emitter 80A and a light receiver 80B respectively disposed on one end (left end in FIG. 3) and on the other end (right end in FIG. 3) of the liquid discharge apparatus 1 in the main scanning direction X. The height detector 80 detects the fabric on the platen 40. The height detector 80 is attached to a frame 2 of the liquid discharge apparatus 1.

Further, the liquid discharge apparatus 1 includes a power button 70, a control panel 71, and a power supply unit 72. When the liquid discharge apparatus 1 prints on a fabric, the fabric is set on the platen 40. Then, the control panel 71 is operated to completely pull the platen 40 in a rear direction (upward in FIG. 2) of the liquid discharge apparatus 1 by moving the slider 42.

When the platen 40 is pulled into the liquid discharge apparatus 1, the liquid discharge apparatus 1 detects whether the fabric on the platen 40 interferes with the head 10 using the height detector 80. When the liquid discharge apparatus 1 determines that the head 10 interferes (collides) with the fabric from the reading result of the height detector 80, the liquid discharge apparatus 1 stops pulling of the platen 40 inside the liquid discharge apparatus 1 or moves the platen 40 back to an initial set position (lower position in FIG. 2) of the platen 40 at which the fabric is to be set on the platen 40.

When the platen 40 is fully (completely) pulled inside the liquid discharge apparatus 1, the liquid discharge apparatus 1 becomes a print-data standby state in which the liquid discharge apparatus 1 waits to receive print data from an external information processing device. The liquid discharge apparatus 1 starts a print operation when the liquid discharge apparatus 1 receives the print data from the external information processing device.

Alternatively, the liquid discharge apparatus 1 may select the print data by the control panel 71 to start the print operation when the print data is previously stored in the controller board 50.

When the liquid discharge apparatus 1 starts the print operation, the liquid discharge apparatus 1 moves the slider 42 to move the platen 40 to a printing start position at which the liquid discharge apparatus 1 starts the print operation. Then, the liquid discharge apparatus 1 moves the carriage 11 while discharging a liquid from the head 10 to perform one line of printing on the fabric. When the liquid discharge apparatus 1 prints the one line, the liquid discharge apparatus 1 moves the slider 42 to move the platen 40 by one line. The liquid discharge apparatus 1 intermittently repeats one scanning movement of the carriage 11 in the main scanning direction X and one movement of the slider 42 in the sub-scanning direction Y to print an image on a desired region on the fabric. The liquid discharge apparatus 1 moves the platen 40 back to the front side (lower side in FIG. 2) of the liquid discharge apparatus 1 to finish the print operation.

An operation of the liquid discharge apparatus 1 will be supplementarily described below. The following description partially overlaps the above description.

The liquid discharge apparatus 1 includes the controller board 50 for processing and controlling, for example, operations (outputs) of a motor and a solenoid, and input signals of a sensor. The controller board 50 performs control based on installed software. For example, the controller board 50 controls printing based on print data transmitted from a personal computer (PC), and also controls printing performed by reading print data recorded in a universal serial bus (USB) memory.

As the main scanning motor 14 drives the timing belt 17, the carriage 11 moves in the main scanning direction X along the guides 12 and 13. The slits are periodically formed or printed on the encoder sheet 18, and the reading sensor on the carriage 11 reads the encoder sheet 18 to detect the position of the carriage 11. The head 10 mounted on the carriage 11 discharges a liquid at a discharge position at a corresponding timing under the control of the controller board 50.

For example, printing is performed on a fabric such as a T-shirt by the DTG system. The fabric such as a T-shirt is set on the platen 40.

The control panel 71 is operated to completely pull the platen 40 in a rear direction (upward in FIG. 2) of the liquid discharge apparatus 1 by moving the slider 42. The height detector 80 detects whether the fabric on the platen 40 interferes with the head 10. When the platen 40 is fully (completely) pulled inside the liquid discharge apparatus 1 without trouble, the liquid discharge apparatus 1 becomes the print-data standby state.

When the liquid discharge apparatus 1 starts the print operation, the liquid discharge apparatus 1 moves the slider 42 to move the platen 40 to the printing start position at which the liquid discharge apparatus 1 starts the print operation. Then, the liquid discharge apparatus 1 moves the carriage 11 while discharging a liquid from the head 10 to perform one line of printing on the fabric. When the liquid discharge apparatus 1 prints the one line, the liquid discharge apparatus 1 moves the slider 42 to move the platen 40 by one line. The liquid discharge apparatus 1 intermittently repeats one scanning movement of the carriage 11 in the main scanning direction X and one movement of the slider 42 in the sub-scanning direction Y to print an image on a desired region on the fabric. The liquid discharge apparatus 1 moves the platen 40 back to the front side (lower side in FIG. 2) of the liquid discharge apparatus 1 to finish the print operation.

Preferably, the DTG printer including a holder such as a platen is also used for the DTF system. However, a transfer substrate such as a film is not easily set on a platen of a DTG printer according to a comparative example. For example, the transfer substrate is fixed on the platen of the comparative example with a tape when the transfer substrate is set, which takes time and effort.

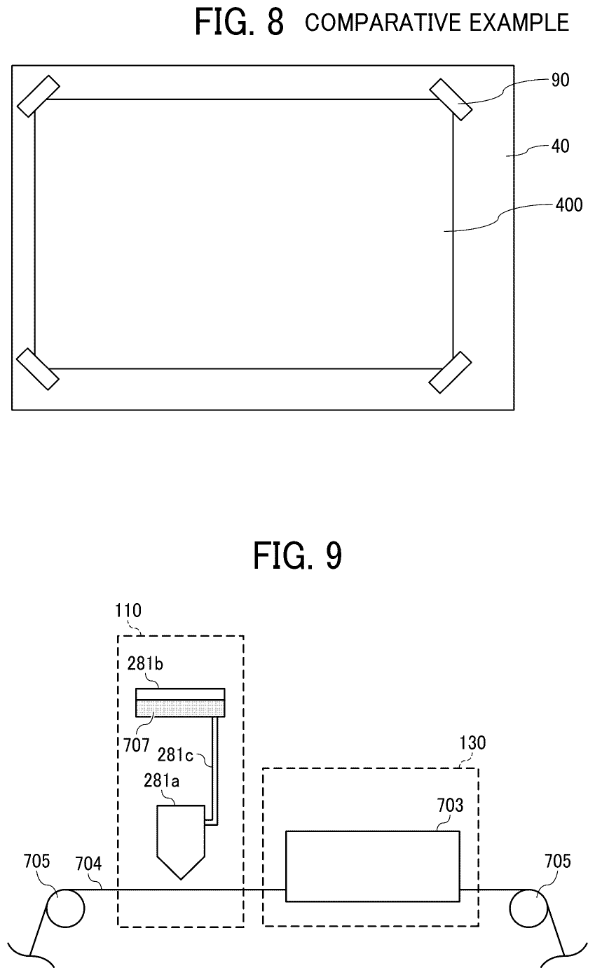

FIG. 8 is a schematic plan view of the platen of the DTG printer according to the comparative example when a film is set on the platen. When a T-shirt is set on the platen 40 of the DTG printer, for example, the T-shirt is fixed by a frame. The DTG printer is not suitable for setting a transfer substrate such as a film. When the transfer substrate is placed on the platen 40, the transfer substrate may be moved on the platen 40 by moving the platen 40. Accordingly, for example, as illustrated in FIG. 8, four corners of a film 400 as the transfer substrate are fixed onto the platen 40 with tapes 90, and such a process lowers productivity.

For example, when a film is used as the transfer substrate, a liquid may not smoothly permeate into the transfer substrate. Thus, in the DTG printer of the comparative example, the liquid may be excessive on the film and may not be sufficiently dried. If the liquid is not sufficiently dried, for example, the liquid may flow (spread) on the film, or the coloring of the liquid may be lowered, causing an abnormal image. If adhesive powder is applied to the liquid which is not sufficiently dried, the liquid layer and the powder are mixed, which may cause an abnormal image such as uneven coloring or insufficient coloring. When a waiting time is provided until the adhesive powder is applied after the printing on the transfer substrate, the liquid layer and the powder are unlikely to be mixed, but productivity is significantly lowered.

Accordingly, in the present embodiment, a heater is disposed on the platen 40 (holder), and an anti-slip member is disposed on the heater. The anti-slip member facilitates the setting of the transfer substrate such as a film on the platen 40. As a result, in the liquid discharge apparatus employing the DTG system and including the holder such as a platen, a transfer substrate for forming an image thereon by the DTF system can be easily set (placed) on the holder. Further, the anti-slip member disposed on the heater on the platen 40 allows the structure of the apparatus to be stable, and a desired image can be formed.

The heater on the platen can accelerate the drying of the liquid discharged onto the transfer substrate, and the transfer substrate can be dried favorably. As a result, an abnormal image due to, for example, ink flowing or insufficient coloring can be prevented. Further, the heater can prevent a decrease in productivity.

### First Example

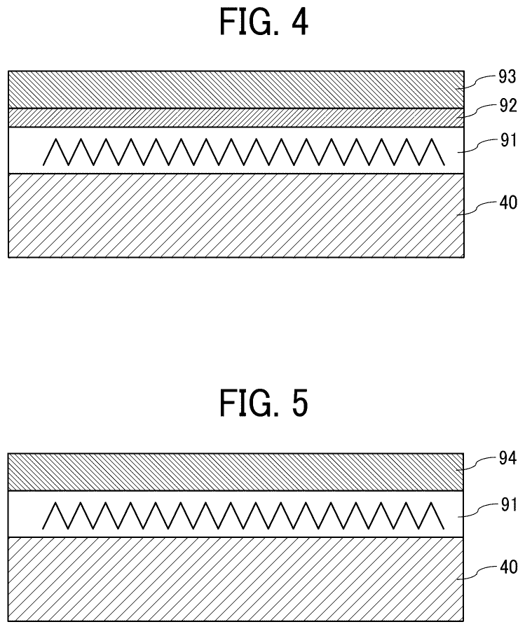

FIG. 4 is a schematic cross-sectional side view of the platen 40. The film 400 is used as the transfer substrate.

A heater sheet 91 is disposed on the platen 40, and a vinyl sheet 93 is disposed on the heater sheet 91. The vinyl sheet 93 may be referred to simply as a sheet 93. In this example, the sheet 93 is adhered to the heater sheet 91 via an adhesive sheet 92.

The heater sheet 91 is an example of a heater. The heater sheet 91 may be fixed to the platen 40 via, for example, an adhesive sheet, or the heater sheet 91 itself may have adhesion to the platen 40.

The heater on the platen 40 can dry a liquid during printing. By drying the liquid during printing, the liquid does not flow on the film 400 when film 400 is moved or inclined immediately after printing. As a result, an abnormal image does not occur. In the DTF system, for example, the adhesive powder is applied to an image, which is to be transferred, formed on the film 400, and then the image is dried at 140 to 170° C.

In this case, moisture of the image may rapidly evaporate, and thus the image may crack. In the present embodiment, the heater on the platen 40 heats the image during printing to prevent the rapid evaporation of moisture and the crack of the image due to the heating after the powder is applied.

Further, the liquid is less likely to flow on the film 400 by the heater on the platen 40 as in the present embodiment than by a blower-type drying mechanism such as a dryer. When an image is dried by the blower-type drying mechanism such as a dryer immediately after the liquid is discharged to the film 400 to form the image, an undried liquid in the image may flow on the film 400 depending on a drying condition such as an air volume, causing an abnormal image such as image unevenness. Such a configuration of the present embodiment can prevent such a situation.

As in the present embodiment, the heater on the platen 40 does not cause the liquid to flow on the film 400. Accordingly, an allowable amount of the liquid to be discharged onto the film 400 to print an image on the film 400 can be increased. As a result, the coloring of the image formed on the film 400 can be enhanced.

The heater is preferably a sheet-shaped heating element like the heater sheet 91 in this example. When the heater is the sheet-shaped heating element, heat is efficiently transferred to the sheet 93 by heat conduction, and thus the liquid can be efficiently dried. Since heat is transferred by heat conduction, the liquid is less likely to flow on the film 400 by the sheet-shaped heating element than by the blower-type drying mechanism such as a dryer.

A heating temperature of the heater sheet 91 is not limited to any particular temperature, and can be appropriately selected. The heating temperature is preferably 20° C. or higher and 60° C. or lower, and more preferably 40° C. or higher and 60° C. or lower. In other words, the heater sheet 91 heats the transfer substrate with a heating temperature of 20° C. or higher and 60° C. or lower. In this case, the heater on the platen 40 can heat an image at a low temperature during printing to prevent the image from cracking due to the rapid evaporation of moisture during printing. When the heating temperature is within such a range, the adhesive powder can be applied to the image immediately after the end of printing.

The heater can be appropriately selected, and for example, a commercially available product may be used. For example, a film heater having a heat source can be used. The heat source is illustrated in the heater sheet 91 in FIG. 4. The connection between the heater sheet 91 and a power supply is not limited to any particular method as long as the platen 40 is movable.

The vinyl sheet 93 is an example of an anti-slip member. When the film 400 contacts the sheet 93, the film 400 is unlikely to move (slip) in an in-plane direction of the sheet 93. As a result, the sheet 93 functions as the anti-slip member. In the present embodiment, the film 400 can be easily set (placed) over the platen 40 by placing the film 400 on the anti-slip member, which is disposed over the platen 40.

The anti-slip member is preferably the vinyl sheet 93 in this example so that the film 400 is easily brought into close contact with or attracted to the sheet 93. In particular, for example, when the film 400 is a film as the transfer substrate, the film 400 is more easily brought into close contact with or attracted to the sheet 93.

As the anti-slip member, sheets other than the vinyl sheet 93 can be appropriately selected and used, and for example, an adhesive sheet described later can be used.

The sheet 93 in this example is preferably a vinyl sheet having a smooth shape (surface). The smooth shape may be any shape without unevenness, and a sheet having high smoothness is preferable. The smoothness can be determined by Bekk method according to Japanese Industrial Standards (JIS) P 8119. Thus, the anti-slip member having a smooth shape (surface) allows the structure of the apparatus to be stable, and a desired image can be formed.

The adhesive sheet 92 is an example of an adhesive body (mya be referred to simply as an “adhesive”). As in the present example, the anti-slip member (e.g., the sheet 93) is preferably disposed on the heater (e.g., the heater sheet 91) via the adhesive body, and the anti-slip member is preferably replaceable. When the anti-slip member is replaceable, if the anti-slip member is stained with the discharged liquid, the anti-slip member can be replaced with a new one. Thus, the film 400 is not affected by the anti-slip member stained with the liquid. When the anti-slip member is stained with the liquid, the function of the anti-slip member may deteriorate. Such deterioration of the function can be eliminated by replacing the anti-slip member. By using the adhesive body, the anti-slip member can be easily replaced.

The shape of the adhesive body is not specified as long as the adhesive body has adhesiveness. A detachable adhesive body may be used. An adhesive having weak adhesion may be used as the detachable adhesive body.

For example, an adhesive tape can be used as the adhesive sheet 92. The adhesive sheet 92 is not necessarily disposed on the entire face of the sheet 93. The adhesive sheet 92 may be disposed on a part of the sheet 93 to adhere the sheet 93 to the heater sheet 91.

The platen 40 may be referred to as, for example, a print medium holder. A portion including the platen 40, the heater sheet 91, the adhesive sheet 92, and the sheet 93 may be referred to as, for example, a platen unit. A portion including the heater sheet 91, the adhesive sheet 92, and the sheet 93 may be referred to as, for example, an anti-slip heating mechanism. Such an anti-slip heating mechanism has a heating function and an anti-slip function, i.e., one mechanism has two functions.

The anti-slip function of the anti-slip member is described below. Friction between the anti-slip member (e.g., the sheet 93) and the film 400 is larger than friction between the platen 40 and the film 400 and friction between the heater on the platen 40 and the film 400 in the in-plane direction of the sheet 93.

The thickness of the anti-slip member is not limited to any particular thickness, but is preferably, for example, 1 to 200 μm. In this case, heat is efficiently transferred from the heater to the transfer substrate through the anti-slip member, i.e., the anti-slip member has good thermal conductivity. Further, the anti-slip member has good handleability and durability.

The liquid discharge apparatus according to the present embodiment can favorably form an image, which is to be transferred onto a transfer target, on a transfer substrate used in the DTF system. The image to be transferred is formed on the transfer substrate, and the formed image is transferred from the transfer substrate to the transfer target. The transfer substrate can be appropriately selected, and for example, a film is used as the transfer substrate.

In the DTF system, for example, adhesive powder is applied to the image, which is to be transferred, formed on the transfer substrate. The surface of the transfer substrate onto which an image to be transferred is formed is brought into contact with the transfer target, and heat or pressure is applied to the transfer substrate and the transfer target to transfer the image from the transfer substrate to the transfer target. The transfer target can be appropriately selected, and examples of the transfer target include a fabric such as a T-shirt.

### Second Example

FIG. 5 is a schematic cross-sectional side view of the platen 40. Descriptions of matters similar to those in the above example will be omitted.

An adhesive sheet 94 is another example of the anti-slip member. When the anti-slip member is the adhesive sheet 94 as in the present example, the number of components of the platen unit can be reduced as compared with the first example, and the anti-slip member (e.g., the adhesive sheet 94) can be easily adhered to the heater sheet 91. Since the adhesive sheet 94 is also replaceable, the film 400 is not affected by the anti-slip member stained with the liquid, similarly to the first example. The adhesive sheet 94 limits the shape of the adhesive body to a sheet shape.

### Third Example

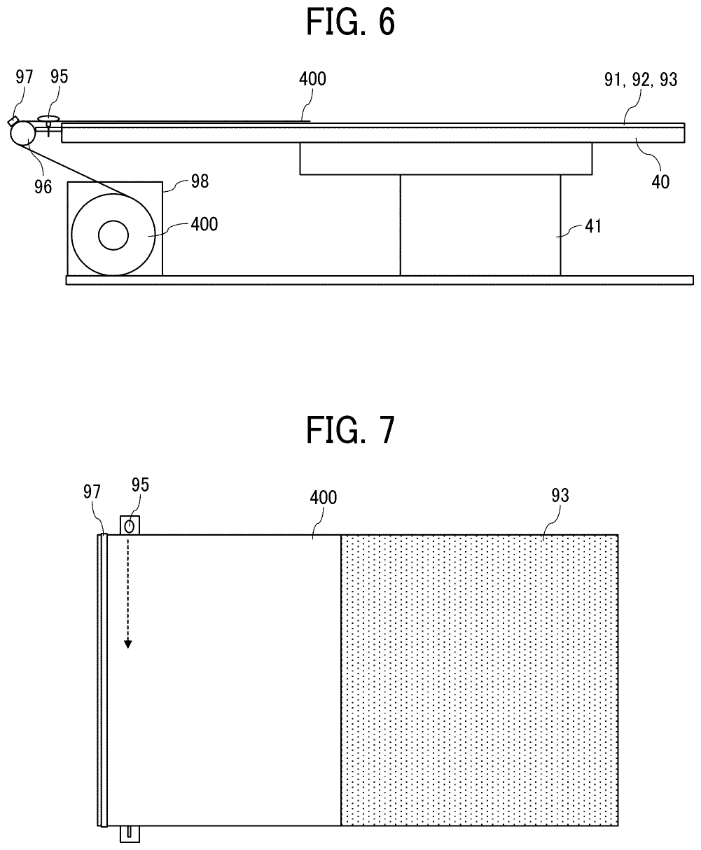

FIG. 6 is a schematic side view of the platen 40 and the surroundings thereof. FIG. 7 is a schematic plan view of a part of the platen 40 of FIG. 6 and the surroundings thereof as viewed from above. Descriptions of matters similar to those in the above example will be omitted.

As illustrated in FIG. 6, the film 400 (i.e., the transfer substrate) in a roll shape is held in a roll film case 98 (i.e., a roll holder). The roll film case 98 is disposed below the platen 40. The film 400 is conveyed from the roll film case 98 onto the platen unit (i.e., the anti-slip member such as the sheet 93) in a conveyance direction by an intermediate roller 96 as a conveyor. A pressing member 97 presses the film 400 against the intermediate roller 96. A cutter 95 is disposed upstream from the platen unit (i.e., the anti-slip member) in the conveyance direction.

The heater sheet 91, the adhesive sheet 92, and the sheet 93 are collectively illustrated in FIG. 6. In FIG. 6, the platen unit includes the platen 40, the heater sheet 91, the adhesive sheet 92, and the sheet 93 as in the first example described above, but may include the platen 40, the heater sheet 91, and the adhesive sheet 94 as in the second example described above.

As illustrated in FIG. 7, for example, after the film 400 is placed on the platen unit, the film 400 can be easily cut in a predetermined size by moving the cutter 95 in the direction indicated by the broken arrow in FIG. 7.

In the third example, the transfer substrate (e.g., the film 400) is accommodated in a roll shape below the platen 40, and the cutter 95 that cuts the transfer substrate is disposed at an upstream end of the platen 40 in the conveyance direction. The transfer substrate is drawn out from below the platen 40 and set on the sheet 93 of the platen unit, then the transfer substrate is cut by the cutter 95. Thus, the head 10 is ready to discharge a liquid onto the transfer substrate.

According to the third example, the transfer substrate (e.g., the film 400) can be drawn and adhered to the anti-slip member, by the length corresponding to the size of an image to be printed. After the film 400 is set on the anti-slip member, the film 400 is cut in the predetermined size by the cutter 95. The predetermined size can be determined based on the size of an image to be printed. By so doing, the film 400 can be more easily set on the anti-slip member of the platen unit, and the positional deviation of the film 400 can be prevented when the film 400 is set on the platen unit. Since the film 400 in a roll shape is used, the film 400 can be easily replenished and replaced. Such a configuration in the present example can facilitate the setting of the film 400 to the platen unit and the detachment of the film 400 from the platen unit.

### Electrode Manufacturing Apparatus

The “liquid discharge apparatus” according to the present embodiment may also include an apparatus for manufacturing an electrode and an electrochemical element that is also referred to as “an electrode manufacturing apparatus.” The electrode manufacturing apparatus is described below.

FIG. 9 is a schematic view of the electrode manufacturing apparatus. The electrode manufacturing apparatus is an apparatus for manufacturing an electrode including a layer containing an electrode material by discharging a liquid composition using a head module including a liquid discharge head.

Device for Forming Layer Containing Electrode Material and Process of Forming Layer Containing Electrode Material

A discharge device in the electrode manufacturing apparatus illustrated in FIG. 9 is a head module (e.g., a discharge process device 110). The liquid discharge head of the head module discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

Structure to Form a Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below. As illustrated in FIG. 9, the electrode manufacturing apparatus includes the discharge process device 110 (i.e., the head module) and a heating process device 130 (i.e., the heating device). The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying a liquid composition 707 onto the print base material 704, a storage container 281b that stores the liquid composition 707, and a supply tube 281c that supplies the liquid composition 707 stored in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heating device 703 of the heating process device 130. Accordingly, the solvent is removed from the liquid composition layer. Thus, the electrode composite layer is formed. The heating process device 130 may perform the solvent removing process under reduced pressure.

The heating device 703 is not limited to any particular heater and may be appropriately selected depending on the intended purpose. For example, the heating device 703 may be a substrate heater, an infrared (IR) heater, or a hot air heater.

The heating device 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The electrode manufacturing apparatus of the present embodiment discharges the liquid composition onto the transfer substrate.

In the present embodiment, the object (discharge target) is the transfer substrate. Heating after discharging the liquid composition can be performed by the heater (e.g., the heater sheet 91) disposed on the holder.

Aspects of the present disclosure are, for example, as follows.

### Aspect 1

A liquid discharge apparatus includes a liquid discharger and a holder. The liquid discharger discharges a liquid onto a transfer substrate. The transfer substrate is placed on the holder. A heater is disposed on the holder, and an anti-slip member is disposed on the heater.

In other words, a liquid discharge apparatus includes a liquid discharger, a platen, a heater, and an anti-slip member. The liquid discharger discharges a liquid onto a transfer substrate. The heater is disposed on the platen. The heater heats the transfer substrate over the platen. The anti-slip member is disposed on the heater. The anti-slip member has a surface on which the transfer substrate is placeable.

### Aspect 2

In the liquid discharge apparatus according to Aspect 1, the anti-slip member is a vinyl sheet.

### Aspect 3

In the liquid discharge apparatus according to Aspect 1 or 2, the heater is a sheet-shaped heating element.

In other words, the heater includes a sheet-shaped heating element.

### Aspect 4

In the liquid discharge apparatus according to any one of Aspects 1 to 3, a heating temperature of the heater is 20° C. or higher and 60° C. or lower.

In other words, the heater heats the transfer substrate with a heating temperature of 20° C. or higher and 60° C. or lower.

### Aspect 5

In the liquid discharge apparatus according to any one of Aspects 1 to 4, the anti-slip member is disposed on the heater via an adhesive body, and the anti-slip member is replaceable.

In other words, the anti-slip member is replaceably adhered to the heater via an adhesive.

### Aspect 6

In the liquid discharge apparatus according to any one of Aspects 1 to 4, the anti-slip member is an adhesive sheet.

In other words, the anti-slip member includes an adhesive sheet.

### Aspect 7

In the liquid discharge apparatus according to any one of Aspects 1 to 6, an image for transfer is formed on the transfer substrate, and the formed image for transfer is transferred to a transfer target.

In other words, the liquid discharger discharges the liquid onto the transfer substrate to form an image to be transferred to a transfer target.

### Aspect 8

In the liquid discharge apparatus according to any one of Aspects 1 to 7, the transfer substrate is disposed below the holder in a roll form. A cutter that cuts the transfer substrate is disposed at an end of the holder. The transfer substrate is cuttable by the cutter after the transfer substrate is drawn out from below the holder and placed on the holder.

In other words, the liquid discharge apparatus according to any one of Aspects 1 to 7, further includes a roll holder, a conveyor, and a cutter. The roll holder is disposed below the platen. The roll holder holds the transfer substrate in a roll shape. The conveyor conveys the transfer substrate from the roll holder onto the anti-slip member in a conveyance direction. The cutter is disposed upstream from the anti-slip member in the conveyance direction. The cutter cuts the transfer substrate on the anti-slip member.

As described above, according to one aspect of the present disclosure, in the liquid discharge apparatus that employs the DTG system and includes the holder such as a platen, when a transfer substrate for forming an image by the DTF system is used, the transfer substrate can be easily placed over the holder (i.e., on a surface of the anti-slip member), the transfer substrate can be dried favorably, and an abnormal image can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus comprising:
a liquid discharger to discharge a liquid onto a transfer substrate;
a platen;
a heater on the platen, the heater to heat the transfer substrate over the platen; and
an anti-slip member on the heater, the anti-slip member having a surface on which the transfer substrate is placeable.

2. The liquid discharge apparatus according to claim 1,
wherein the anti-slip member is a vinyl sheet.

3. The liquid discharge apparatus according to claim 1,
wherein the heater includes a sheet-shaped heating element.

4. The liquid discharge apparatus according to claim 1,
wherein the heater heats the transfer substrate with a heating temperature of 20° C. or higher and 60° C. or lower.

5. The liquid discharge apparatus according to claim 1,
wherein the anti-slip member is replaceably adhered to the heater via an adhesive.

6. The liquid discharge apparatus according to claim 1,
wherein the anti-slip member includes an adhesive sheet.

7. The liquid discharge apparatus according to claim 1,
wherein the liquid discharger discharges the liquid onto the transfer substrate to form an image to be transferred to a transfer target.

8. The liquid discharge apparatus according to claim 1, further comprising:
a roll holder below the platen to hold the transfer substrate in a roll shape;
a conveyor to convey the transfer substrate from the roll holder onto the anti-slip member in a conveyance direction; and
a cutter, upstream from the anti-slip member in the conveyance direction, to cut the transfer substrate on the anti-slip member.
